(19) United States
(12) Patent Application Publication
(10) Pub. No.: US 2005/0200118 A1
(43) Pub. Date: Sep. 15, 2005

(54) Non-impact printable, substantially planar jewelry repair form with integrated pressure sensitive label and detachable tag

(76) Inventor: Roger D. Buck, Pittsburg, KS (US)

Correspondence Address: WARD KRAFT, INC., P.O. BOX 938, FORT SCOTT, KS, 66701, US

(21) Appl. No.: 10/800,967

(22) Filed: Mar. 15, 2004

(51) Int. Cl. B42D 15/00

(52) U.S. Cl. 283/62

(57) ABSTRACT

The present invention relates to a substantially planar business form assembly for use in jewelry repair or delivery. The business form assembly can be provided in a cut sheet arrangement in which each business form is provided with an envelope portion and at least a record portion for tracking and custody preservation. The record portion is provided with one or more removable labels and a receipt section. The envelope portion may have one or more closure flaps to enable the ready sealing and resealing of the construction so that the article can be sealed at one location, worked on and returned to the originating location without loosing the integrity of the form assembly and its contents.

### CROSS-REFERENCES TO RELATED APPLICATIONS

None.

### FIELD OF THE INVENTION

The present invention relates to a combination business form including an envelope or pouch that is suitable for use in the repair, maintenance, processing and handling of jewelry, e.g. rings, bracelets, watches and similar items where there is a need to track and return such articles. More specifically, the present invention is a non-impact printable business form construction that is substantially planar and utilizes a series of separable integrated pressure sensitive labels and detachable tag to track and identify the contents of the envelope. The business form construction of the present invention has first and second parts, with one of the parts comprising a secure envelope and the other portion making up the business form and information carrying piece.

### BACKGROUND OF THE INVENTION

With the growth of large, “big box” and other multiple discipline retailers and the desire to offer customers a one-stop shopping opportunity, many of these large retailers currently have jewelry or other collectible or other specialty sales counters that enable consumers to browse a variety of available offerings while looking for other goods within the store. The advent of such large variety retail centers thus utilizes general sales personnel at specialty stations or sales counters who often know little or nothing at all about the jewelry and other collectibles or specialites that are being offered for sale. Rather, such personnel are merely filling the position to which they have been assigned. As such, when special or unique product (other than general merchandise) is returned by a customer after a sale for servicing, such as for sizing, alterations, engraving or repair or alternatively, the product is received by the retail outlet in a damaged condition, with the absence of skilled technicians or artisans at the retail location, the product must be sent to another location for evaluation such as to the corporate head office or to a private contractor for repair of the article.

Presently, jewelry or other collectibles or specialities that are being returned for servicing normally requires the clerk at the retail outlet to dispatch the item in a conventional plastic bag, mail envelope or the like and the item is cataloged for purposes of recording the transaction. Unfortunately, this process requires significant manual intervention and can be time consuming. In addition, the return merchandise envelope may often be generic and too large and thus not generally suitable for use with jewelry such as rings and other small articles.

Still other difficulties with prior art solutions includes the security of the piece and maintaining the integrity of the service claim or chain of custody of the item so that the piece can be tracked and returned safely to the original location from which the piece was submitted for repair or alteration by a customer.

Other problems associated with prior art solutions include forms having differential thicknesses in which one or more portions of the form assembly have a different thickness than other areas of the form. This can make processing and imaging of the form difficult for the purpose of recording information and some information to be printed may be blurred as the toner may not be sufficiently affixed in position or the ink is deposited out of registry with the area or character to be imaged.

Security envelopes have heretofore been used, principally in the carriage of currency, bonds or other negotiable instruments. Exemplary constructions include U.S. Pat. Nos. 3,933,304, 4,720,040 and 4,941,196. These constructions normally provide a transparent bag, produced from a synthetic material and have a tamper evident closure such that upon opening, the seal displays indicia to indicate opening. Such constructions normally have a single section or compartment, however U.S. Pat. No. 4,720,040 has a second compartment. However, the constructions are limited in the amount of information that can be provided as there is no separate business form portion having a plurality of parts. In addition, the see through nature of the product enables the contents to be clearly visible. In the case of currency or bonds, the serial numbers can be traced, however most jewelry contains no identifying marks or if such marks are provided it can be readily and easily removed. As such, there generally would be a desire to conceal the contents to prevent their misappropriation. In addition, currency or other negotiable instruments typically will not puncture a bag, even if the contents include coinage as there are no sharp points on the notes or coins.

Other business forms that include an envelope and receipt portions include constructions that are used in the processing of photographic films, such as those provided in U.S. Pat. Nos. 3,764,061, 4,310,117 and 5,102,035. However, such products while providing a record portion for the submitter, these constructions are generally not adaptable for use in non-impact printing equipment as they are not substantially planar and instead need to be filled out or completed by insertion of hand written indicia.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a substantially planar business form combination which includes one section having one or more removable labels and a receipt piece and a second section that is constructed to form an envelope configuration. The invention includes matching indicia that is imaged on each of the labels and receipt portion to facilitate tracking and custody of the article of jewelry contained within the envelope portion.

In one embodiment of the present invention, a jewelry repair form is described and includes a substrate that has front and back faces, first and second longitudinally extending sides and first and second transversely extending end edges. The substrate has a length and a width that is distinct from one another, and the substrate is divided in to first and second portions. A first adhesive pattern is applied to one of the first and second portions on the first face of the substrate. The pattern of adhesive extends along one of the first and second transversely extending end edges and along a portion of each of the first and second longitudinally extending side edges.

Still referring to the presently described embodiment, a first sheet is applied over the first adhesive pattern on the first portion so as to form an envelope. The envelope that is formed from the combination of a portion of the substrate and the first sheet has three sealed edges and one open edge. A second adhesive pattern is used and applied on the second portion on the first face of the substrate. Then, a second sheet is applied over the second adhesive pattern to create a number of removable labels on an integrated label portion. The second sheet covers more than a majority of the second portion of the substrate.

In the presently described embodiment, the substrate with the envelope portion and the integrated label portion forms a substantially planar business form and envelope combination for use in repairing jewelry articles.

In a further embodiment of the present invention, an envelope and integrated label business form combination for use in delivery of jewelry is described and includes a first sheet that has front and rear faces, first and second sides and top and bottom end edges. The sheet has a length and a width that are distinct from one another.

In this embodiment, a second sheet is included and has first and second sides and first and second end edges and a width that is substantially equal to the width of the substrate. This second sheet is adhered to a first portion of the substrate such that the sides of the substrate are in substantial alignment with the sides of the second sheet to form a partial enclosure for containing a jewelry piece. The enclosure is open on one of the edges or sides.

This presently described embodiment also includes a third sheet that has first and second sides and first and second end edges. The third sheet has a width that is substantially equal to the substrate and a length which is substantially less than the substrate. The third sheet is adhered to a second portion of the substrate such that the sides of the substrate are in substantial alignment with the sides of the third sheet. The substrate with the third sheet creates a number of removable labels and a receipt section.

In this embodiment, the enclosure and the removable label and receipt section are separated from one another by a line of demarcation (fold line, perforation line or other suitable means to define the sections or portions) and at least one of the first, second or third sheets provides a closure flap for the enclosure. Each of the second and third sheets are adhered to the front face of the substrate so as to create a substantially planar assembly for use in delivering jewelry.

In a yet still further embodiment of the present invention a combination jewelry article and substantially planar business form is described and includes an article of jewelry. The combination further includes a business form that has first and second parts, with the first part comprising an envelope formed from a substrate that has a width and length. A U-shaped pattern of adhesive is applied to the first part of the substrate and a first sheet having a width and length is applied over the pattern of adhesive. The length of the first sheet is less than the length of the substrate. The substrate and the first sheet has a substantially equal width and the first sheet is juxtaposed on a portion of the substrate to create a covered portion for forming the envelope that has one open end and an exposed portion. The envelope that is formed is sized and configured so as to receive the article of jewelry.

In the presently described business form, the form further includes at least one removable label and receipt section. The section is formed on the exposed portion of the substrate (that portion not covered by the envelope) and includes a pattern of pressure sensitive adhesive and a second sheet at least substantially covering the pattern of adhesive. At least a first closure flap is provided for sealing the open end of the envelope after the article of jewelry has been inserted. This construction also includes a line of demarcation that separates or distinguishes the envelope portion from the labels section. In order to achieve sufficient tracking and record keeping, indicia is provided on at least one of the removable labels and the receipt section, such that the indicia on each of the receipt and the label includes matching information.

In alternative embodiments, the business form construction of the present invention may also include a separable receipt or record portion that will typically be applied to the second face or opposite face to that of the envelope and removable label portion. This record portion can be used to carry other information related to the order, such as special instructions or requests by the customer or submitter of the article.

The envelope included with these exemplary constructions may also be provided with supplemental padding or cushioning, such as through the inclusion of an insert or through the creation of ridges and valleys on the materials that are used to form the envelope or on an insert for an envelope.

The envelope may also be provided with one or more adhesive closure flaps that can be used in the sealing and resealing of the enclosure such that the enclosure can be opened for inspection or to perform work and then returned in the same envelope to provide a continuous chain of custody for the form product.

A yet still further embodiment of the present invention includes a non-impact printable sheet of business forms that are suitable for use in jewelry repair or delivery and which include a sheet of material having dimensions of roughly 8½″ by 11″ and the sheet of material has first and second business forms that are separable from one another by a line of weakness. Each of the first and second business forms have an envelope portion and a record portion, with the record portion having at least one removable label and at least one receipt or tag. Each of the business forms when joined with one another in the sheet of material provide a substantially planar assembly for processing through a non-impact printer.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the business form combination of the present invention;

FIG. 2 provides a cross section of the business form combination;

FIG. 2A illustrates a cut away front view of the present invention depicting the adhesive patterns used in creating the construction;

FIG. 3 shows an alternative configuration of the present invention showing the use of a plurality of closure flaps;

FIG. 4 depicts the combination of an article of jewelry enclosed in the envelope portion in a sealed configuration and further providing an exemplary padded embodiment;

FIG. 5 provides a cross section of the envelope portion showing an exemplary padded arrangement; and

FIG. 6 shows plural business forms of the present invention in cut sheet format suitable for processing through a non-impact printer.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The business form constructions described by the instant specification are provided in a substantially planar arrangement and include plural sections, one of which is an envelope or partial enclosure (having an opening) and the other is a record portion with at least one removable pressure sensitive label and receipt or tag portion.

The business form assembly as described herein is suitable for use in the transmission, delivery of an article of jewelry or other item of enhanced value, whether sentimental or monetary, for the purposes of handling, processing, repair, servicing or the like which has been requested by an owner or customer of an article.

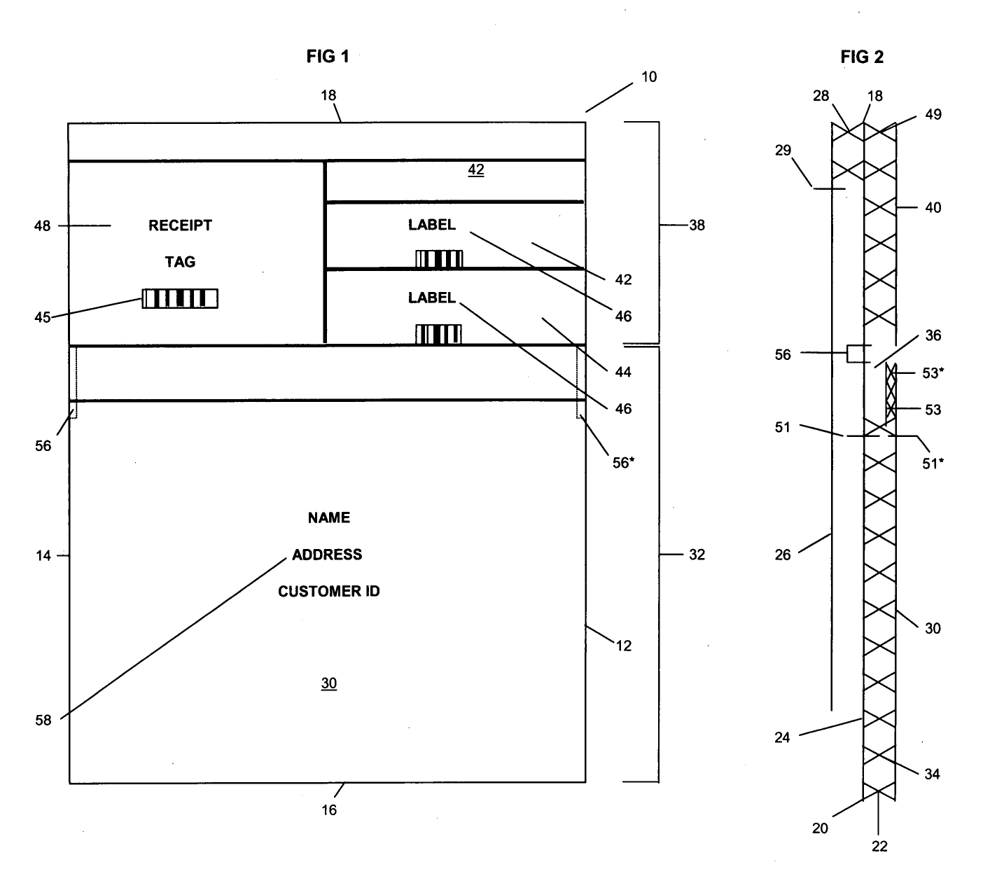

Turning now to FIG. 1, a front view of the business form assembly of the present invention is provided and generally referred to by reference numeral 10. The assembly 10 has a length (longitudinal direction) of approximately 8½ inches and a width (transverse direction) of approximately 5½ inches. The assembly 10 has first and second longitudinally extending side edges 12 and 14 and first and second transversely extending end edges 16 and 18. The end edges 16 and 18 may also be referred to herein as top and bottom edges.

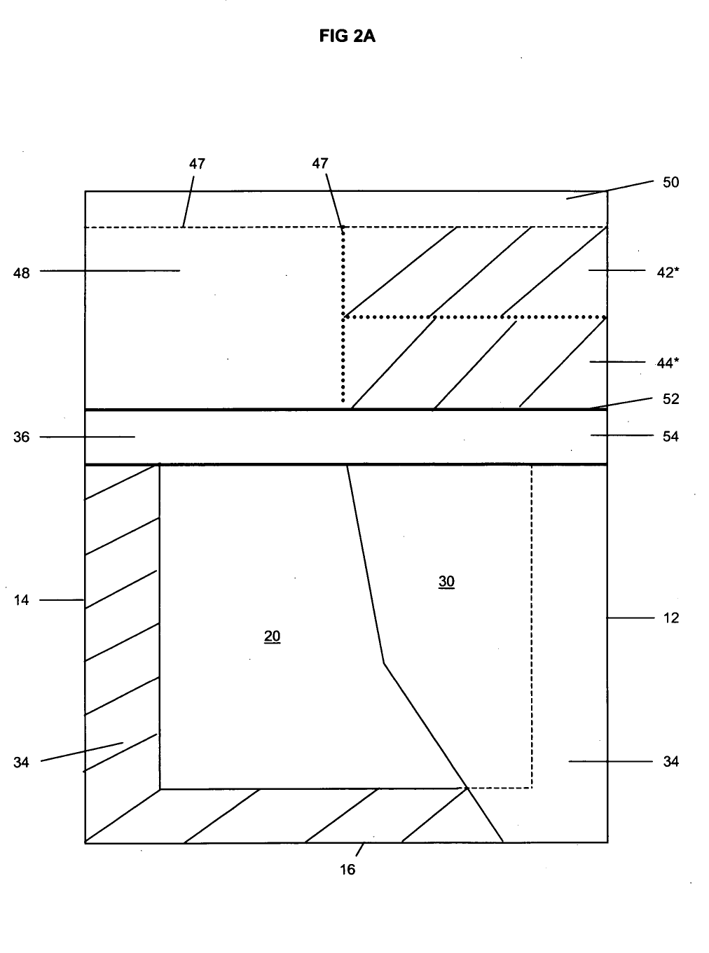

The assembly 10 is composed of a substrate 20, shown in FIG. 2 that has front and back or first and second faces 22 and 24. FIG. 2 also provides the assembly 10 with an additional record ply 26 which is attached to the substrate 20 along end edge 18 through adhesive 28. A perforation line 29 may be provided so that the record ply 26 can be separated from the assembly 10.

The additional record ply may have a carbonless coating on the back side of the sheet so that record information can be transferred to second face 24 of the substrate 20. That is, a CF/CB coating is provided on the respective sheets so that upon imparting pressure to the sheet 26 the pressure ruptures the capsules contained in the coating and transfers the image to the substrate 20 second face 24. In such an arrangement, additional information such as engraving to be provided on the article of jewelry could be provided on the form. It should be understood that instead of a carbonless coatings, carbon interleaves may be provided. In addition, there may be plural record plies provided so that copies can be made and retained.

FIG. 2 also provides a first sheet 30, see also FIG. 1, which has first and second side and end edges. The side edges of the first sheet 30 are in alignment with the sides 12 and 14 of the assembly 10. In addition, one end edge of the sheet 30 is alignment with one of the end edges 16 of the substrate 20. The sheet 30 is juxtaposed on top of the substrate so that the three edges are in substantial alignment with the first portion 32 of the assembly 10. Sheet 30 is secured to the substrate 20 through use of an adhesive 34. The adhesive 34 is provided generally in a “U” shaped pattern as may be seen in FIG. 2A. The pattern 34 may be continuous our may be provided in strips, segments or other patterns so that a seal is created to form an enclosure sealed along three sides with an opening 36 (FIG. 2) provided at one end to enable the envelope to be opened an articles inserted therein.

The assembly 10 is also provided with a second portion 38 (FIG. 1) which makes up the record portion of the assembly, regardless of whether a supplemental record ply 26 is provided (FIG. 2). The second portion includes a second sheet 40, as shown in FIG. 2 that has side and end edges. The side edges of the second sheet 40 are in substantial alignment with the side edges 12 and 14 of the substrate 20. Sheet 40, in this FIGURE is shown adjacent end edge 18 of substrate 20.

Sheet 40 in FIG. 1 is provided with first and second removable labels 42 and 44. Each of the labels is provided with indicia 46 which may include store codes, bar codes, combinations of alpha and numeric imaging and the like. Additional and matching indicia 46 is provided on the receipt portion 48 which when removed is given to the customer or requestor of the services or alternatively is retained by the transmitting location. Sheet 40 is secured to the first face 22 of the substrate 20 by means of a pressure sensitive adhesive 49 which again may be applied in a particular pattern in order to create the removable labels 42 and 44 of the present invention.

The substrate 20 and sheet 30 which will make up the envelope of the business form construction should be selected from an appropriate stock that is both laser printable and second will not readily tear due to the insertion or transport of the article to and from the service location. Suitable material may include Tyvek® available from DuPont, Corp. of Wilmington, Del., tag stock such as 100 pound stock, coated paper where a varnish or other strengthener is applied so as to make the stock less apt to tear during handling. 20 pound bond paper may be used in certain instances, for example when relatively flat articles are being handled by the envelope. Construction preferences would then be subject to the demands of the user of the form assembly 10 and are not generally dictated by one preference or another. For example, a retail outlet that repairs flat chains or bands would likely not be as restricted in the types of materials as one that principally services articles having exposed points (rings) that could rip through the surface of sheets 20 or 30.

FIG. 2A is shows a cutaway of the assembly 10 provided in FIG. 1 and is used to illustrate the generally “U” shaped pattern of adhesive 34, part of which is shown in phantom by dotted/dashed lines. In this view, the front face of sheets 20 and 30 can be seen. While the substrate 20 is typically provided with the pattern 34 of adhesive, it should be understood that the adhesive could be pre-applied to sheet 30 and then the sheet 30 place in alignment with the substrate 20 to create the envelope pocket. In addition, while the opening 36 of the envelope is provided on an opposite end of sheet 30 from the sealed end edge 16, it should be understood that the opening 36 could be provided at end edge 16 or on either side edge 12 or 14 depending on the need or application of the user. Such realignment would merely require that the pattern of adhesive would be repositioned to accommodate the available open end. The closure flap, as will later be discussed herein would also then have to be positioned over the area occupied by the opening so that the envelope may be closed.

FIG. 2A also shows the pattern coating of adhesive 42* and 44* that is used to create the removable labels shown in FIG. 1. As is understood by those skilled in the art, removable labels are created through the application of release coating, and in this example, to the first or top face 22 of the substrate 20 so that when peeling force is applied to the labels, the adhesive 42* or 44*, depending on the label being removed, will adhere to the label and not to substrate 20, thus allowing the label to be applied to the envelope portion 32.

The receipt portion 48 may be also be a removable label, constructed as described above, or simply a tag that can be removed from the second portion 38 though a series of die cuts 47. Alternatively, the tag may be held in place by a frangible bond, such as is available under the trademark DRITAC™ available from Ward/Kraft, Inc., of Fort Scott, Kans.

The record portion 38 may be provided with a closure flap 50 for the envelope portion 32 on one end edge 18 of the sheet 40. In this embodiment, the record portion 38 after the one or more of the labels and tag have been removed may be folded over line of demarcation 52 and the flap sealed near the end edge 16 of the assembly, thereby closing the envelope opening 36. Alternatively, or in addition to closure flap 50, another closure flap 54 may be provided adjacent the opening 36 so that the record portion may be separated from the envelope portion along the line of demarcation 52 and then the flap 54 folded over the envelope opening 36. Where the flap 54 is secondary to flap 52, the secondary flap may be used to return the envelope to the originating location. If flap 54 is the principal or primary flap, then the record portion 38 is removed prior to sealing of the closure 36 of the envelope portion 32.

For ease of convenience in the description, the closure flaps are preferably created through the use of a transfer tape (see FIG. 2) in which a release liner 53 covers an adhesive 53*. When in use, the user removes the liner 53, and folds the exposed portion of the sheet or substrate, having adhesive 53* thereon, over the envelope opening. It should be understood that the closure flap and the transfer tape may be provided on the substrate 20, sheet 30 or record sheet 40. For example, in FIG. 2, the closure flap is provided on sheet 30. In use, the record portion 38 is removed through perforation line 51 and the closure flap is folded about opening 36 through use of fold line 51*. If the closure flap were provided on the substrate 20 or sheet 40, reposition of the fold and perforation lines 51 and 51* would be required as is readily understood by those having skill in the art.

Referring back to FIG. 1, gaps 56 and 56* are provided adjacent the opening 36 of the envelope portion 32. These gaps 56 and 56* are created in an area between the adhesives used to create the envelope and the record portion and as may be further illustrated in FIG. 2. The gaps or vents 56 and 56* used to allow air to escape from the envelope portion 32 during the processing of the assembly 10 such as through a non-impact printer, so as to avoid problems with tenting or bubbling of the form which may lead to distortion of the printing of the form, such as used to add customer information (name, address, identification number) as depicted by reference numeral 58 in FIG. 1. These gaps may also allow for partial adhesive ooze as well thereby preventing forms when placed in a stack, such as in an infeed tray of a printer, from sticking together as the adhesive or coatings can flow into the gap without being exposed to other forms.

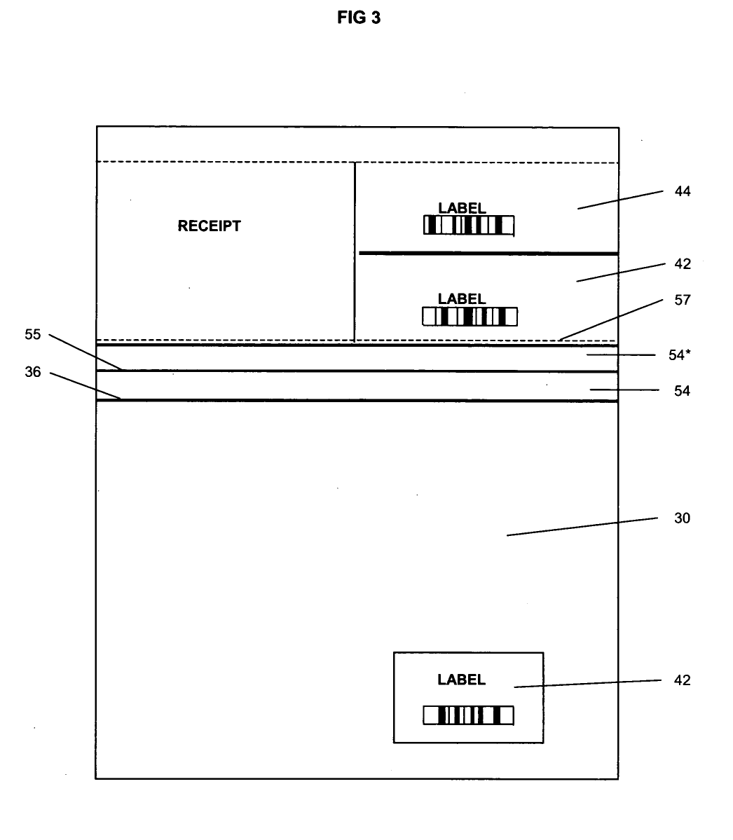

Turning now to FIG. 3, which provides a front view of the assembly 10 and illustrates an alternative closure arrangement for the envelope opening 36. In this embodiment, first and second closure flaps 54 and 54* are provided. In this embodiment, the record portion would be detached along line of weakness 57 and then the second closure flap 54* would be utilized first and the transfer tape, as described above would be removed. Both flaps 54 and 54* would then be folded over the opening with the exposed adhesive of flap 54* contacting the top face of sheet 30. The envelope portion would then be opened along line 55 so that the first flap remains adhered to the top face of the envelope and the second flap 54 folded back so that the contents of the envelope may be removed and serviced as requested.

After servicing of the contents of the envelope, the second closure flap 54 has its transfer tape removed and is folded over the envelop opening so that the envelope may be resealed and returned. FIG. 3 also depicts the use of one of the removable labels 42 that has been applied to the first face of the sheet 30 to aid in the tracking and delivery of the envelope and contents.

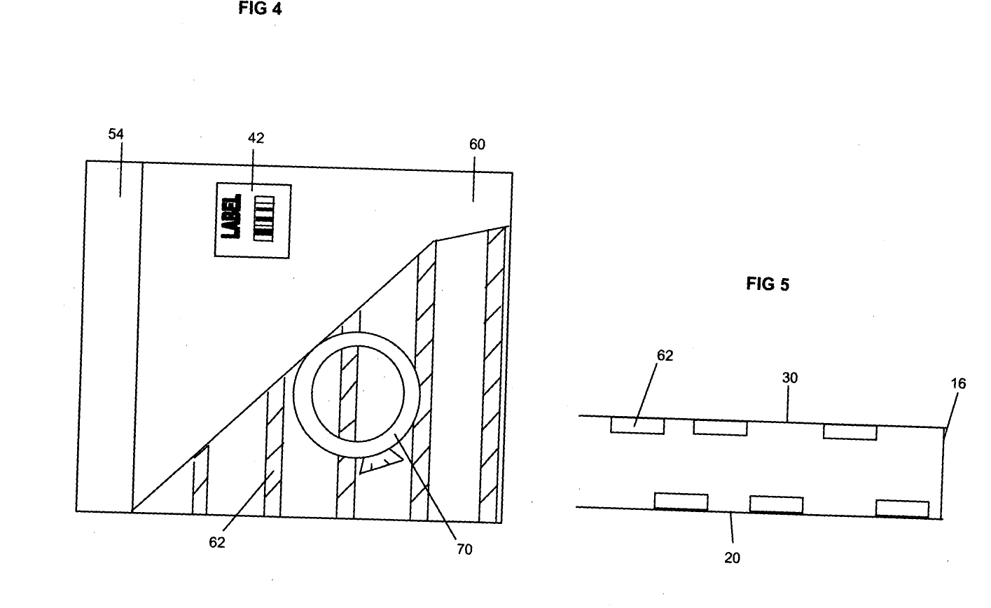

FIG. 4 shows the envelope 60 in use. The envelope has been sealed with one flap 54 in this embodiment and an article of jewelry 70 has been enclosed in the envelope. Label 42 has been applied to the envelope 60 to provide tracking and servicing information. Placement of the label is not particularly critical however it should be available for scanning and reading.

The cut away of envelope 60 also shows padding material 62 that has been provided to the envelope to cushion the article 70 and potentially protect it from damage during transit. The padding 62 may be provided through the use of cushioning such as “bubble wrap”, fibrous fill, or the envelope 60 itself may be calendared so as to create ridges and valleys or an insert having ridges and valleys may be provided internally of the envelope.

As seen in FIG. 5 the cushioning or padding 62 may be provided in a pattern so as to increase the cushioning effect. In FIG. 5, the sheets 20 and 30 have each been calendared so as to create the ridges and valleys of the present invention.

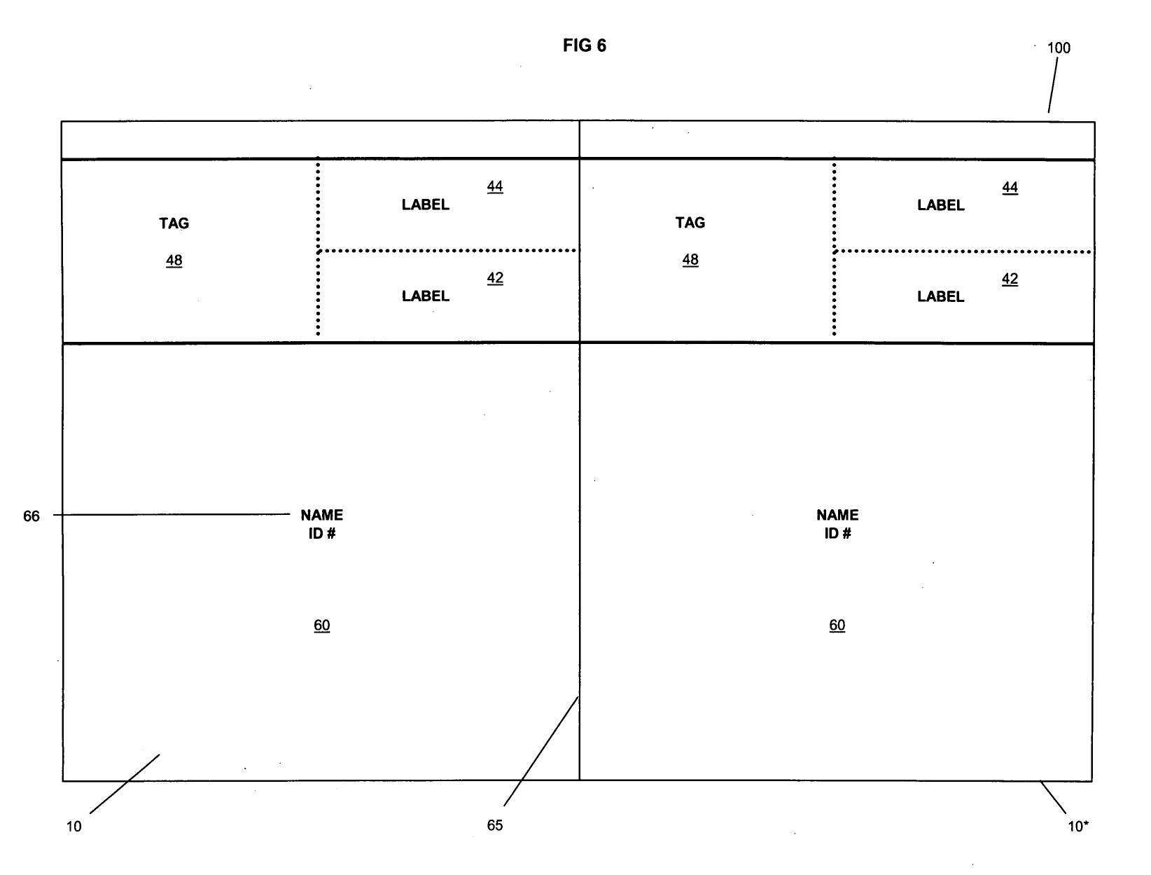

Turning now to FIG. 6 of the present invention, a pair of business form assemblies 10 and 10* are provided in a non-impact printable sheet configuration such as a standard sheet having dimensions of roughly 8½ inches by 11 inches. The assemblies 10 and 10* are shown in a side by side configuration and may be processed in either a landscape or portrait configuration in the sheet configuration 100. Each of the assemblies 10 and 10* is printed with indicia 66 as well as each of the labels 42 and 44 and tag portion 48. The indicia that is provided on each of the respective parts ideally contains some matching or related indicia which ties the assembly 10 or 10* to a particular user or customer. The assemblies 10 and 10* are separable from one another either by cutting along line 65, or where such apparatus is not available then they may be separated along a line of perforation or the like at the use location.

In use, the retail outlet would receive a customer and take information about the article or piece that is to be serviced. The service or retail representative would then input the information into a computer, such as a personal computer that may be connected to a printer and other computers via a local area network or a global communications network. Upon completing the input of data, the service personnel then prints the information on an assembly in areas such as the envelope 60, labels 42 and 44 and tag portion 48. The labels 42 and 44 can be removed and attached to the envelope 60 and the tag is given to the customer. Alternatively, one of the labels may be applied to the tag to provide additional information and tracking for the customer. If an additional recordation ply 26 is provided, that ply can be filled out manually with any additional information that may be related to the transaction being contemplated.

Next, the service personnel places the article of jewelry, such as a ring 70 in the envelope 60 and then seals the opening of the envelope through use of one or more closure flaps that have been provided and depending on the configuration. Where the closure flaps are adjacent one another as shown in FIG. 3, the record portion is detached after the tags and labels have been removed and the flaps folded over the opening of the envelope. Alternatively, and as described above, the flap on the record portion can be used to seal the envelope assembly.

It will thus be seen according to the present invention a highly advantageous substantially planar business form combination for repairing and delivering articles of jewelry has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A jewelry repair form, comprising;
a substrate having front and back faces, first and second longitudinally extending sides and first and second transversely extending end edges, said substrate having a length and a width that are distinct from one another, and said substrate is divided in to first and second portions;
a first adhesive pattern is applied to said first portion on said first face of said substrate and extending along one of said first and second transversely extending end edges and along a portion of each of said first and second longitudinally extending side edges;
a first sheet applied over said first adhesive pattern on said first portion so as to form an envelope along with said substrate, said envelope having three sealed edges and one open edge;
a second adhesive pattern applied on said second portion on said first face of said substrate;
a second sheet applied over said second adhesive pattern to create a number of removable labels on an integrated label portion and said second sheet covering more than a majority of said second portion; and
said substrate with said envelope portion and said integrated label portion forming a substantially planar business form and envelope combination for use in repairing jewelry articles.

2. A jewelry repair form as recited in claim 1, wherein said open edge of said envelope portion is provided with an adhesive closure.

3. A jewelry repair form as recited in claim 2, wherein said adhesive closure is provided through use of a transfer tape.

4. A jewelry repair form as recited in claim 2, wherein said adhesive closure is provided through use of a rewettable adhesive.

5. A jewelry repair form as recited in claim 2, wherein said adhesive closure is provided through use of a cohesive pattern.

6. A jewelry repair form as recited in claim 1, wherein said substrate is provided with at least one detachable record ply on said second face and connected along one of said end edges or side edges.

7. A jewelry repair form as recited in claim 1, wherein a gap is created between said first sheet and said substrate to reduce tenting of said jewelry repair form.

8. A jewelry repair form as recited in claim 7, wherein said gap is between said envelope portion and said integrated label portion.

9. A jewelry repair form as recited in claim 1, wherein said integrated label portion includes a receipt tag.

10. A jewelry repair form as recited in claim 1, wherein said envelope is provided with a closure flap formed from a section of said integrated label portion.

11. A jewelry repair form as recited in claim 1, wherein each of said first and second sheets have a width substantially equal to said width of said substrate.

12. A jewelry repair form as recited in claim 1, wherein said envelope portion and said integrated label portion are separated by a line of demarcation.

13. A jewelry repair form as recited in claim 1, wherein said envelope portion is provided with padding.

14. A jewelry repair form as recited in claim 13, wherein said padding is created by inserting a cushioning material.

15. A jewelry repair form as recited in claim 13, wherein said padding is created by developing ridges and valleys either on said substrate and said first sheet of said envelope portion or on an insert.

16. An envelope and integrated label business form combination for use in delivery of jewelry, comprising;
a first sheet having front and rear faces, first and second sides and top and bottom end edges, said first sheet having a length and a width distinct from one another;
a second sheet having first and second sides and first and second end edges, a width substantially equal to said substrate and adhered to a first portion of said substrate such that said sides of said substrate are in substantial alignment with the sides of said second sheet to form a partial enclosure for containing a jewelry piece, said enclosure is open on one of said edges or sides;
a third sheet having first and second sides and first and second end edges, a width substantially equal to said substrate and a length substantially less than said substrate, said third sheet is adhered to a second portion of said substrate such that said sides of said substrate are in substantial alignment with the sides of said third sheet, said substrate with said third sheet creating a number of removable labels and a receipt section;
said enclosure and said removable label and receipt section are separated from one another by a line of demarcation and at least one of said first, second or third sheets provides a closure flap for said enclosure; and
each of said second and third sheets are adhered to said front face of said substrate so as to create a substantially planar assembly for use in delivering jewelry.

17. An envelope and integrated label business form combination as recited in claim 16, wherein said combination includes at least first and second closure flaps with each of said closure flaps having an adhesive closure.

18. An envelope and integrated label business form combination as recited in claim 17, wherein one of said closure flaps is provided on said removable label and receipt section and another of said closure flaps is provided on said envelope portion.

19. An envelope and integrated label business form combination as recited in claim 16, wherein said label and receipt section is provided with matching indicia on each of said label and receipt.

20. A combination jewelry article and substantially planar business form, comprising;
an article of jewelry;
a business form having first and second parts, said first part comprising an envelope formed from a substrate having a width and length, a U-shaped pattern of adhesive is applied to said first part and a first sheet having a width and length is applied over said pattern of adhesive, said first sheet has a length that is less than said length of said substrate, said substrate and said first sheet having a substantially equal width and said first sheet is juxtaposed on a portion of said substrate to create a covered portion for forming said envelope having one open end and an exposed portion;
said envelope is sized and configured so as to receive said article of jewelry;
said business form further including at least one removable label and receipt section, said section is formed on said exposed portion of said substrate and includes a pattern of pressure sensitive adhesive and a second sheet at least substantially covering said pattern of adhesive;
at least a first closure flap for sealing said open end of said envelope after said article of jewelry is inserted;
a line of demarcation to separate said envelope from said section; and
indicia provided on said at least one removable label and said receipt section, said indicia on each of said receipt and said label includes matching information.

21. A non-impact printable sheet of business forms suitable for use in jewelry repair or delivery, comprising;
a sheet of material having dimensions of roughly 8½″ by 11″ and said sheet of material having first and second business forms separable from one another by a line of weakness;
each of said first and second business forms including an envelope portion and a record portion, said record portion having at least one removable label and at least one receipt; and
each of said business forms when joined with one another in said sheet of material provide a substantially planar assembly for processing through a non-impact printer.
